(19) United States
(12) Patent Application Publication
(10) Pub. No.: US 2026/0229126 A1
(43) Pub. Date: Aug. 6, 2026

(54) AUTOMATIC COLLECTION AND DISSEMINATION OF PILOT REPORT

(71) Applicant: Honeywell International Inc., Charlotte, NC (US)

(72) Inventors: Kantha Chikkegowda, Bengaluru (IN); Naveen Venkatesh Prasad Nama, Bengaluru (IN)

(21) Appl. No.: 19/178,137

(22) Filed: Apr. 14, 2025

(30) Foreign Application Priority Data
Feb. 6, 2025 (IN) 202511009857

(51) Int. Cl. G08G 5/20; G08G 5/34

(52) U.S. Cl. CPC G08G 5/20; G08G 5/34

(57) ABSTRACT

Automatic collection and dissemination of a pilot report is described herein. One embodiment includes automatically collecting, by an avionics system of an aircraft, data for preparing a pilot report (PIREP), preparing, by the avionics system of the aircraft, a virtual PIREP that includes the collected data, sending, by the avionics system of the aircraft, the virtual PIREP to a computing device located remotely from the aircraft, determining, by the computing device, additional aircraft to send the virtual PIREP to based on the data included in the virtual PIREP and conditions associated with the additional aircraft, and automatically sending, by the computing device, the virtual PIREP to the additional aircraft.

### PRIORITY INFORMATION

This application claims priority pursuant to 35 U.S.C. § 119(a) to India Patent Application No. 202511009857, the contents of which are incorporated herein by reference.

### TECHNICAL FIELD

The present disclosure relates generally to devices, methods, and systems for automatic collection and dissemination of a pilot report.

### BACKGROUND

A pilot report (PIREP) is a report of actual flight conditions, such as, for instance, weather conditions, encountered by an aircraft during flight. Information in a PIREP can be utilized by pilots of other aircraft to provide a safe and controlled flight. A PIREP (e.g., the information in a PIREP) may be organized in a specific (e.g., FAA approved) format.

### BRIEF DESCRIPTION OF THE DRAWINGS

FIG. 1 illustrates a block diagram of an example aircraft avionics system in accordance with one or more embodiments of the present disclosure.

FIG. 2 illustrates a block diagram of an example of a system for automatic collection and dissemination of pilot reports in accordance with one or more embodiments of the present disclosure.

FIG. 3 illustrates an example of a method for automatic collection and dissemination of pilot reports in accordance with one or more embodiments of the present disclosure.

FIG. 4 illustrates an example of a method for automatic collection and dissemination of pilot reports in accordance with one or more embodiments of the present disclosure.

FIG. 5 illustrates an example of a method for automatic collection and dissemination of pilot reports in accordance with one or more embodiments of the present disclosure.

FIG. 6 illustrates an example of a method for automatic collection and dissemination of pilot reports in accordance with one or more embodiments of the present disclosure.

### DETAILED DESCRIPTION

Devices, methods, and systems for automatic collection and dissemination of a pilot report are described herein. One embodiment includes automatically collecting, by an avionics system of an aircraft, data for preparing a pilot report (PIREP), preparing, by the avionics system of the aircraft, a virtual PIREP that includes the collected data, sending, by the avionics system of the aircraft, the virtual PIREP to a computing device located remotely from the aircraft, determining, by the computing device, additional aircraft to send the virtual PIREP to based on the data included in the virtual PIREP and conditions associated with the additional aircraft, and automatically sending, by the computing device, the virtual PIREP to the additional aircraft.

As noted above, PIREPs (e.g. the information included in a PIREP) are an important part of aircraft safety procedures. However, in some instances, a pilot may not submit a PIREP because it can be difficult and/or cumbersome for the pilot to do so on the flight deck or offline, and/or because the pilot may not perceive their flight conditions as worth reporting. Further, even if the pilot does submit a PIREP, the information may not be disseminated in time to assist other pilots. Such PIREP submission and dissemination issues can reduce the effectiveness of the PIREP and lead to aircraft accidents.

Embodiments of the present disclosure, however, can address these PIREP submission and dissemination issues by automatically collecting the data for preparing a virtual PIREP, which can then be sent to an artificial intelligence-based cloud computing system for further processing. The cloud computing system can then disseminate the virtual PIREP to other aircraft according to conditions associated with those aircraft, such as aircraft type, weather, region, and/or historical analytics. As such, embodiments of the present disclosure can ensure the PIREP effectively increases aircraft safety while also reducing the workload for the pilot.

As an example, an avionics system of an aircraft can automatically collect data for preparing a PIREP. This data can include weather data, such as lightning, icing, turbulence, hail, and/or wind data, and data about the aircraft, such as the location of the aircraft, the altitude of the aircraft, and/or the type of the aircraft. The avionics system of the aircraft can prepare and format a virtual PIREP that includes the collected data. In some instances, the avionics system can display the virtual PIREP to the pilot of the aircraft for review and approval.

The avionics system can send (e.g., transmit) the virtual PIREP to a cloud computing device, which can determine additional aircraft (e.g., other aircraft that subscribe to the cloud computing system) to send the virtual PIREP to, and automatically send the virtual PIREP to those aircraft. The cloud computing device can determine the additional aircraft to send the virtual PIREP to based on the data included in the virtual PIREP and conditions associated with the additional aircraft. For example, the cloud computing device can determine other subscribing aircraft that have conditions associated therewith that match the data included in the virtual PIREP, and send the virtual PIREP to those aircraft. For instance, the virtual PIREP can be sent to other subscribing aircraft that are the same type of aircraft as the aircraft from which the virtual PIREP was received, that have the same flight path as the aircraft from which the virtual PIREP was received, that are experiencing the same weather as the aircraft from which the virtual PIREP was received, and/or that are in the same location and/or region as the aircraft from which the virtual PIREP was received. The avionics system of the additional aircraft can automatically display the virtual PIREP to the pilot of the additional aircraft upon receiving the virtual PIREP.

In some examples, the avionics system of the aircraft can automatically send the virtual PIREP directly to the additional aircraft. For instance, the avionics system can automatically send the virtual PIREP to other subscribing aircraft within the vicinity of the aircraft.

In some examples, the avionics system of the aircraft can send the virtual PIREP to a ground-based aircraft control system, such as an aeronautical operational control (AOC) system or an air traffic control (ATC) system. The ground-based system can provide further targeted transmission of the virtual PIREP based on the aircraft flying in the region, as well as use the virtual PIREP to proactively modify the flight plans of other aircraft to avoid severe weather or take advantage of tail winds.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

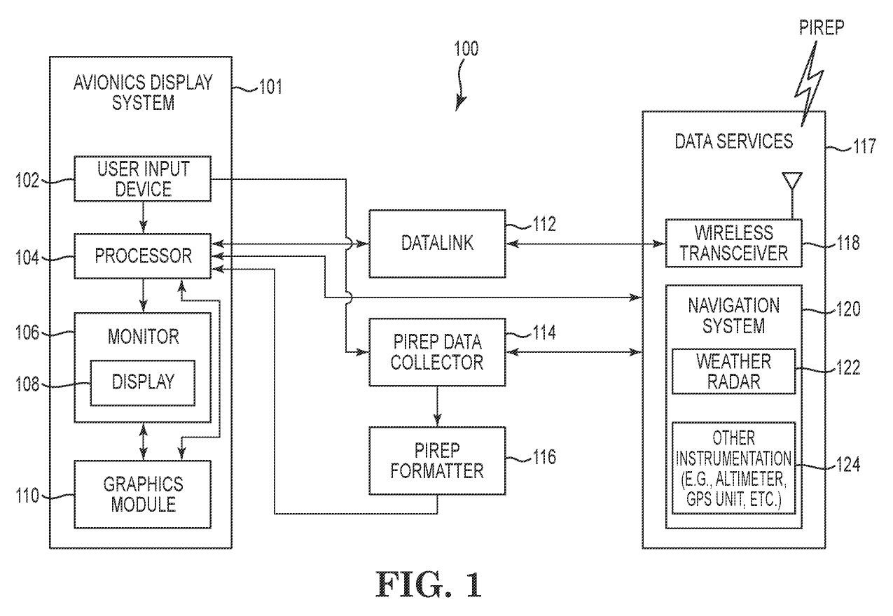

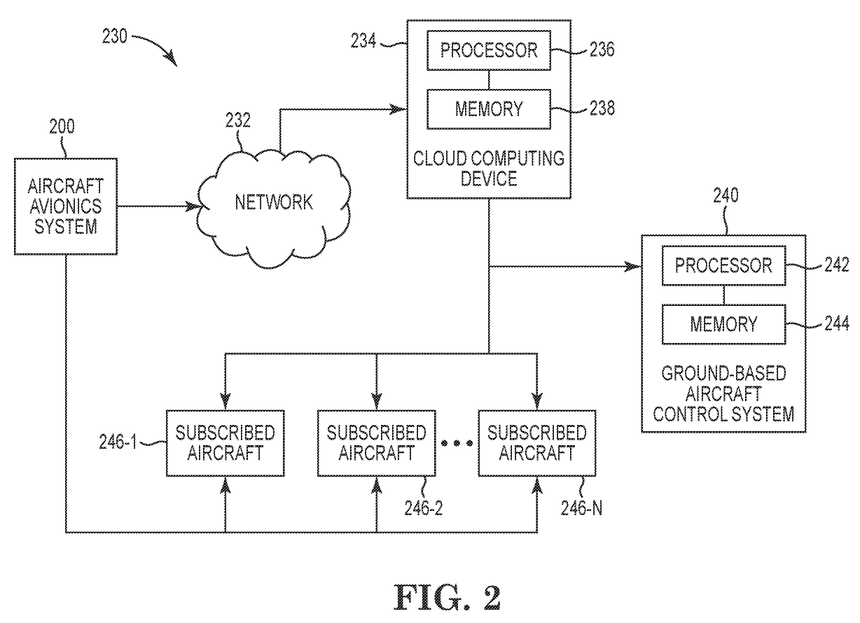

The figures herein follow a numbering convention in which the first digit or digits correspond to the drawing figure number and the remaining digits identify an element or component in the drawing. Similar elements or components between different figures may be identified by the use of similar digits. For example, 100 may reference element “00” in FIG. 1, and a similar element may be referenced as 200 in FIG. 2.

As used herein, “a”, “an”, or “a number of” something can refer to one or more such things, while “a plurality of” something can refer to more than one such things. For example, “a number of aircraft” can refer to one or more aircraft, while “a plurality of aircraft” can refer to more than one component. Additionally, the designator “N”, as used herein, particularly with respect to reference numerals in the drawings, indicates that a number of the particular feature so designated can be included with a number of embodiments of the present disclosure.

FIG. 1 illustrates a block diagram of an example aircraft avionics system 100 in accordance with one or more embodiments of the present disclosure. As shown in FIG. 1, aircraft avionics system 100 includes an avionics display system 101. Avionics display system 101 includes a processor 104 and a monitor 106, which is operatively coupled to processor 104. During operation of avionics display system 101, processor 104 drives graphics module 110 which, in conjunction with processor 104, drives monitor 106 to produce a display 108 that visually provides a pilot and crew with information pertaining to the host aircraft, neighboring aircraft, and weather within a predetermined vicinity of the host aircraft. Display 108 may include visual representations (textual and graphical) of one or more of flight characteristics pertaining to a neighboring aircraft and weather. Processor 104 may generate display 108 in a two-dimensional format (e.g., as a lateral or vertical profile map display) or in a hybrid format (e.g., in a picture-in-picture or split screen arrangement) and may be incorporated into all units capable of displaying data (e.g., the primary flight display, the multi-function display, and the interactive navigation display). Display 108 may also be comprised of a touch screen display.

Processor 104 may comprise, or be associated with, any suitable number of individual microprocessors, flight control computers, navigational equipment, memories, power supplies, storage devices, interface cards, and other standard components known in the art. In this respect, the processor 104 may include or cooperate with any number of software programs (e.g., avionics display programs) or instructions designed to carry out the various methods, process tasks, calculations, and control/display functions further described herein. For example, processor 104 may be included within a Flight Management Computer of the type commonly deployed within a Flight Management System (FMS).

Image-generating devices suitable for use as monitor 106 include various analog (e.g., cathode ray tube) and digital (e.g., liquid crystal, active matrix, plasma, etc.) display devices. In some embodiments, monitor 106 may assume the form of a Head-Down Display (HDD) or a Head-Up Display (HUD) included within an aircraft's Electronic Flight Instrument System (EFIS). Monitor 106 may be disposed at various locations throughout the cockpit. For example, monitor 106 may comprise a primary flight display (PFD) and reside at a central location within the pilot's primary field-of-view. Alternatively, monitor 106 may comprise a secondary flight deck display, such as an Engine Instrument and Crew Advisory System (EICAS) display, mounted at a location for convenient observation by the aircraft crew but that generally resides outside of the pilot's primary field-of-view. In some embodiments, monitor 106 may be worn by one or more members of the flight crew.

As shown in FIG. 1, aircraft avionics system 100 includes data services 117. Data services 117 can include a wireless transceiver 118 operatively coupled to a first input of processor 104, via datalink 112. Further, data services can include a navigation system 120 coupled to processor 104 that includes weather radar 122 and other onboard instrumentation 124 such as a radio altimeter, a barometric altimeter, a global positioning system (GPS) unit, and the like. In some embodiments, navigation system 120 may be included within a FMS.

Weather radar 122 can detect and locate extreme weather (e.g. rain, snow, hail, etc.) by detecting reflectivity or returned echoes from the target and displaying the weather on a display (e.g. display 108). That is, weather data is provided from weather radar 122 to processor 104. This data is processed and provided to graphics module 110 which, in turn, is coupled to monitor 122. The weather symbology is then displayed on display 108.

The output of (e.g., data collected by) weather radar 122 and the other onboard instrumentation 124 is also provided to pilot report (PIREP) data collector 114, which collects and stores the data. A PIREP formatter 116 receives data from PIREP data collector 114 and, in conjunction with processor 104, graphics module 110, and monitor 106, can prepare a virtual PIREP that includes the data, as will be further described herein.

FIG. 2 illustrates a block diagram of an example of a system 230 for automatic collection and dissemination of pilot reports (PIREPs) in accordance with one or more embodiments of the present disclosure. As shown in FIG. 2, system 230 can include aircraft avionics system 200, which can be avionics system 100 previously described in connection with FIG. 1.

Aircraft avionics system 200 (e.g., navigation system 120, PIREP data collector 114, and formatter 116 previously described in connection with FIG. 1) can automatically (e.g., without pilot instruction or interaction) collect data for preparing a PIREP, and prepare a virtual PIREP that includes the collected data. The data collected and used for preparing the PIREP can include, for example, weather data, such as lighting data, icing data, turbulence data, hail data, and/or wind data, among other types of weather data. The data can also include the location, region, altitude, and/or type of the aircraft. The data can be included in the virtual PIREP in according to a prescribed encoding procedure.

As an example, the following flight conditions can be included in the PIREP: height and coverage of cloud bases, tops, and layers; flight visibility; restrictions to visibility and weather occurring at altitude; air temperature and changes to temperature with altitude or range; direction and speed of wind aloft; duration and intensity of turbulence; weather conditions and cloud cover through mountain passes and over ridges and peaks; location, extent, and movement of thunderstorms and/or tornado activity; and excessive winds aloft, low level wind shear, and other phenomena bearing on safety and efficiency of flight. Turbulence data can include location, altitude, or range of altitudes, and aircraft type, and can include whether in clouds or clear air. The degree of turbulence, intensity, and duration (e.g., occasional, intermittent, and continuous) can be determined by the pilot. Icing data can include location, altitude or range of altitudes, aircraft type, air temperature, intensity, and type of icing. The following weather data can be classified as URGENT (UUA): tornadoes, funnel clouds, or waterspouts; severe or extreme turbulence (including clear air turbulence); hail; low level wind shear; air speed fluctuations of 10 knots or more; volcanic eruption, ash clouds, and/or detection of sulfur dioxide (SO.sub.2) in the cabin; and any other weather phenomena reported which are considered by the specialist as being hazardous or potentially hazardous to flight operations.

In the PIREP, each data element can be identified by a Text Element Indicator (TEI); the PIREP can include the TEIs for message type, location, time, altitude/flight level, aircraft type, to describe the reported phenomena; each TEI except message type can be preceded with a space and a solidus (/); each TEI except altitude/flight level can be followed by a space; zeros can be inserted in reported values when the number of digits in the report is less than the number required by the format; only authorized aircraft designators and contractions may be used; a three character alphanumeric identifier can be included to describe locations or routes; only authorized identifiers may be used; and entries of TEIs, except as listed above, for which no data has been collected can be omitted. As an example, the PIREP may include the following fields:

UUA- Message type: Urgent PIREP

UA- Message type: Routine PIREP

/OV- Location with reference to a VHF NAVAID or an airport. A three or four alphanumeric identifier can be used. If appropriate, the identifier and three digits to define a radial and three digits to define the distance in nautical miles can be encoded. EXAMPLE: /OV ABC 045020 DEF 120005.

/TM- Time that the reported data or phenomenon occurred or was encountered. Time in four digits GMT can be included. EXAMPLE: /TM 0915.

/FL- Altitude/flight level. The altitude where the phenomenon was first encountered can be included in hundreds of feet (MSL). If not known, UNKN (unknown) can be entered. If the aircraft is climbing or descending, the appropriate contraction (DURC or DURD, respectively) can be included in the remarks. If the condition was encountered within a layer, the altitude range can be included in the appropriate TEI describing the condition. EXAMPLE: FL310.

/TP- Aircraft type. If not known, UNKN can be entered. Icing and turbulence data should also include the aircraft type. EXAMPLE: /TP L329.

/SK- Sky cover. This can include cloud layer amounts and the height of the cloud base. Heights can be in hundreds of feet above sea level using three digits. Abbreviations in this group incldue "CLR" (clear), "BKN" (broken), and "OVC" (overcast). EXAMPLE: /SK 038 OVC045.

/WX- Flight visibility and flight weather. Weather data can be included as follows: Flight visibility, if included, will be the first entry in the /WX field. This can be entered as FV followed by a two-digit visibility value rounded down, if necessary, to the nearest whole statute mile. EXAMPLE: FV01 TRW (thunderstorm).

/TA- Air temperature. Outside air temperature can be reported in degrees Celsius using two digits. Negative temperatures can be prefixed with an "M". EXAMPLE: /TA 15, TA 15M.

/WV- Wind direction and speed. The direction from which the wind is blowing can be specified using three figures, with directions less than 100 degrees preceded by a "0". For example, a wind direction of 90 degrees is coded as 090. The speed can be coded in whole knots using the hundreds digit (if not zero) and the tens and units digits. The wind group ends with "KT" to indicate that winds are reported in knots. Speeds of less than 10 knots can be coded using a leading zero. For example, a wind speed of 8 knots can be coded 08KT and a wind speed of 112 knots can be coded 112KT.

/TB- Turbulence. Intensity, type, and altitude can be included as follows: for intensity, LGT (light), MOD (moderate), EV (severe), or EXTRM (extreme). Range or variation of intensity can be separated with a hyphen; for example, MOD-SEV. If turbulence was not encountered, NEG (negative) can be entered. For type, CAT (clear air turbulence) or CHOP (choppy air) can be included if reported by the pilot. Altitude can be included only if it differs from the value reported in /FL. When a layer of turbulence is included, the height values can be separated with a hyphen. If lower or upper limits are not defined, BLO (below) or ABV (above) can be used. EXAMPLE: /TB LGT-MOD BLO-090.

/IC- Icing. The intensity can be indicated using contractions TRACE, LGT, MOD, or SEV. The reports of a range or variation of intensity can be separated with a hyphen. If icing was not encountered, NEG can be included. The icing type can be included as RIME (a type of ice), CLR, or MX (mixed). The icing altitude may be included only if different from the value reported in the /FL TEL. A hyphen can separate different layers of icing. ABV or BLO can be used when a layer is not defined. EXAMPLE: /IC SVR CLR 028-045.

/R- Remarks. This TEI can include data or a phenomenon which is considered important but does not fit in any of the other TEIs. This can include, but is not limited to, low level wind shear (LLWS) reports, thunderstorm lines, coverage and movement, size of hail (1/4'' increments), lightning, clouds observed but not encountered, geographical or local description of where the phenomenon occurred, International Standard Atmospheric (ISA) reports and contrails. Hazardous weather can be included first. In addition, LLWS should be included first to the extent possible. EXAMPLE: /RM LLWS--15KT SFC-003 DURGC RNWY 22.

As shown in FIG. 2, system 230 can include computing device 234 located remotely from aircraft avionics system 200. For instance, computing device 234 can be a cloud-based computing device. Aircraft avionics system 200 can communicate with computing device 234 via network 232, as illustrated in FIG. 2. For example, aircraft avionics system 200 can send the virtual PIREP to computing device 234, and computing device 234 can receive the virtual PIREP from aircraft avionics system 200, via network 232, as illustrated in FIG. 2. For instance, aircraft avionics system 200 can transmit the virtual PIREP to computing device 234 using wireless transceiver 118 previously described in connection with FIG. 1.

Network 232 can be a network relationship through which equipment aircraft avionics system 200 and computing device 234 can communicate. Examples of such a network relationship can include a distributed computing environment (e.g., a cloud computing environment), a wide area network (WAN) such as the Internet or a LoRaWAN, a local area network (LAN), a personal area network (PAN), a campus area network (CAN), or metropolitan area network (MAN), among other types of network relationships. For instance, network 232 can include a number of servers that receive information from, and transmit information to, aircraft avionic system 200 and computing device 234 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices, such as computing device 234, together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

In some embodiments, aircraft avionics system 200 (e.g. avionics display system 101 previously described in connection with FIG. 1) can display the virtual PIREP to the pilot of the aircraft for the pilot to review and approve prior to sending the virtual PIREP to computing device 234. For example, the pilot may review the virtual PIREP and determine whether the virtual PIREP should be sent to computing device 234 (e.g., the virtual PIREP will be sent to computing device 234 only if the pilot determines it should be sent). In some embodiments, aircraft avionics system 200 can send the virtual PIREP to computing device 234 without displaying the virtual PIREP to the pilot (e.g., without first receiving pilot review and approval). For example, the pilot may choose not to be involved with the virtual PIREP review and sending process. Whether the virtual PIREP is displayed to the aircraft for review and approval prior to sending can be a configurable setting set by the pilot in aircraft avionics system 200.

As shown in FIG. 2, computing device 234 can include a processor 236 and a memory 238. The memory 238 can be any type of storage medium that can be accessed by the processor 236 to perform various examples of the present disclosure. For example, the memory 238 can be a non-transitory computer readable medium having computer readable instructions (e.g., executable instructions/computer program instructions) stored thereon that are executable by the processor 236 for automatic collection and dissemination of pilot reports (e.g., virtual pilot reports) in accordance with the present disclosure.

The memory 238 can be volatile or nonvolatile memory. The memory 238 can also be removable (e.g., portable) memory, or non-removable (e.g., internal) memory. For example, the memory 238 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 238 is illustrated as being located within computing device 234, embodiments of the present disclosure are not so limited. For example, memory 238 can also be located internal to another computing resource (e.g., enabling computer readable instructions to be downloaded over the Internet or another wired or wireless connection).

The processor 236 may be a central processing unit (CPU), a semiconductor-based microprocessor, and/or other hardware devices suitable for retrieval and execution of machine-readable instructions stored in memory 238.

Computing device 234 can (e.g., processor 236 can execute the instructions stored in memory 238 to) determine additional aircraft (e.g., aircraft other than the aircraft from which the virtual PIREP was received) to send the virtual PIREP to based on the data included in the virtual PIREP and conditions associated with the additional aircraft. For example, computing device 234 can determine which aircraft have conditions associated therewith that match the data included in the virtual PIREP, and send the virtual PIREP to those aircraft. For instance, computing device 234 can identify aircraft that are the same type of aircraft as the aircraft from which the virtual PIREP was received, aircraft that are experiencing the same weather conditions as the aircraft from which the virtual PIREP was received, aircraft with the same flight path as the aircraft from which the virtual PIREP was received, aircraft in the same region and/or location as the aircraft from which the virtual PIREP was received, and/or aircraft at the same altitude as the aircraft from which the virtual PIREP was received, and send the virtual PIREP to those aircraft.

Computing device 234 can also determine the additional aircraft to send the virtual PIREP to based on whether those aircraft are subscribed to a PIREP subscription service. For example, computing device 234 can determine (e.g. identify) which aircraft are subscribed to the subscription service, and send the virtual PIREP to those aircraft.

Computing device 234 can automatically send (e.g., disseminate) the virtual PIREP to the additional aircraft. For instance, in the example illustrated in FIG. 2, computing device 234 can send the virtual PIREP to aircraft 246-1, 246-2, . . ., 246-N (which may be collectively referred to herein as aircraft 246) that are subscribed to the PIREP subscription service and have conditions associated therewith that match the data included in the virtual PIREP.

Computing device 234 can send the virtual PIREP to aircraft 246 via a network, such as network 232 or a different network analogous to network 232 (not shown in FIG. 2 for simplicity and so as not to obscure embodiments of the present disclosure). As an additional example, computing device 234 can send the virtual PIREP to aircraft 246 without using a data connection established with a ground-based aircraft control system (e.g., ground-based aircraft control system 240 illustrated in FIG. 2). For instance, computing device 234 can send the virtual PIREP to aircraft 246 using an automatic dependent surveillance-broadcast (ADS-B) or a transponder.

In some embodiments, aircraft avionics system 200 can send the virtual PIREP directly to subscribed aircraft 246, as illustrated in FIG. 2. Aircraft avionics system 200 can send the virtual PIREP to aircraft 246 via any suitable aircraft-to-aircraft communication system (not shown in FIG. 2 for simplicity and so as not to obscure embodiments of the present disclosure).

Upon receiving the virtual PIREP, aircraft 246 can format the virtual PIREP and display the virtual PIREP to its pilot. For example, aircraft 246 can receive, format, and display the virtual PIREP using an aircraft avionics system analogous to aircraft avionics system 100 previously described in connection with FIG. 1.

The pilot of aircraft 246 can take an action based on the virtual PIREP. For example, the pilot can adjust the flight path of the aircraft based on the virtual PIREP (e.g., based on the information included in the virtual PIREP). For example, if the virtual PIREP indicates that there is a storm ahead in the flight path of the aircraft 246, the pilot can adjust the altitude of the aircraft 246 to avoid the storm.

In some instances, aircraft 246 may be not be equipped with weather radar or access to third-party weather services. Embodiments of the present disclosure can increase safety for such aircraft by providing them with the virtual PIREP.

Computing device 234 can also automatically send (e.g., disseminate) the virtual PIREP to a ground-based aircraft control system 240 that is subscribed to the PIREP subscription service, as illustrated in FIG. 2. Computing device 234 can send the virtual PIREP to ground-based aircraft control system 240 via a network, such as network 232 or a different network analogous to network 232 (not shown in FIG. 2 for simplicity and so as not to obscure embodiments of the present disclosure). Ground-based aircraft control system 240 can be, for example, an aeronautical operational control (AOC) system or an air traffic control (ATC) system.

As shown in FIG. 2, ground-based aircraft control system 240 can include a processor 242 and a memory 244, which can be analogous to processor 236 and memory 238, respectively, of cloud computing device 234. For instance, ground-based aircraft control system 240 can include a computing device having processor 236 and memory 238.

Upon receiving the virtual PIREP, ground-based aircraft control system 240 can (e.g., processor 242 can execute instructions stored in memory 244 to) send (e.g., disseminate) the virtual PIREP to other aircraft. For example, in embodiments in which ground-based aircraft control system 240 is an ATC system, the ATC system (e.g., an air traffic controller of the ATC system) can send the virtual PIREP in a targeted transmission, such as, for instance, to targeted aircraft in a particular region. For instance, ground-based aircraft control system 240 can use artificial intelligence to identify target regions that may be under a risk based on weather forecasts received from third-party weather service providers. System 240 can identify subscribed aircraft expected to be flying in the target regions within a particular (e.g. configurable) time period, and send the virtual PIREP to those aircraft.

Additionally or alternatively, upon receiving the virtual PIREP, ground-based aircraft control system 240 can modify the flight plans of other aircraft based on the virtual PIREP (e.g., based on the information included in the virtual PIREP), and send the modified flight plans to their respective aircraft. For example, in embodiments in which ground-based aircraft control system 240 is an AOC system, the AOC system (e.g., a controller of the AOC system) can optimize the flight plans for a fleet of aircraft controlled by the AOC system, and send the optimized flight plans to the fleet. For instance, the optimized flight plans can allow the aircraft of the fleet to avoid severe weather and/or take advantage of tail winds in regions where the weather permits.

In some embodiments, ground-based aircraft control system 240 can define the conditions under which aircraft avionics system 200 must prepare virtual PIREPs, and send the defined conditions to aircraft avionics system 200 in order to trigger (e.g., arm) aircraft avionics system 200 as to when virtual PIREPs must be prepared and sent to cloud computing device 234. For example, ground-based aircraft control system 240 can use automation mechanisms that use a combination of artificial intelligence, historical data analysis, and weather forecasts from third party weather service providers to trigger the collection of the virtual PIREPs at the right time and the right context.

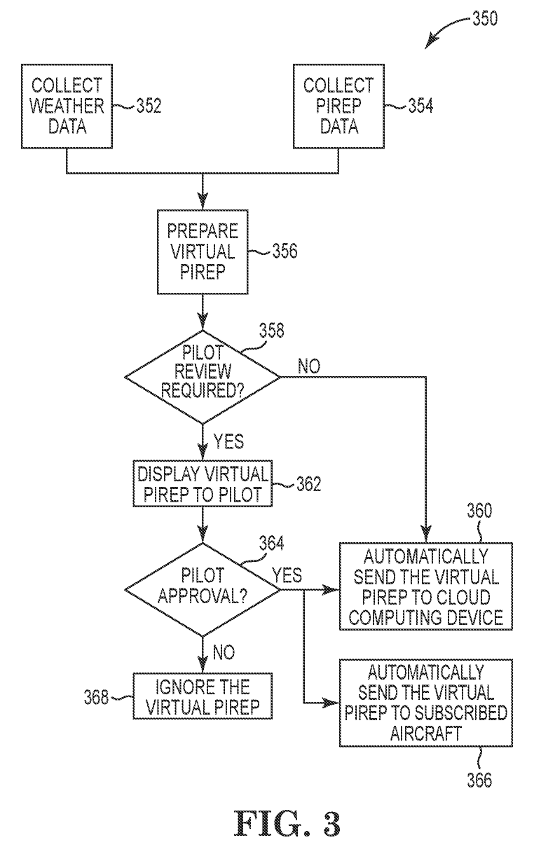

FIG. 3 illustrates an example of a method 350 for automatic collection and dissemination of pilot reports in accordance with one or more embodiments of the present disclosure. Method 350 can be performed by, for example, aircraft avionics system 100 and/or 200 of an aircraft previously described in connection with FIGS. 1 and 2, respectively.

At block 352, method 350 includes collecting weather data, and at block 354, method 350 includes collecting other PIREP data. The weather data can include, for example, lighting data, icing data, turbulence data, hail data, and/or wind data, as previously described herein, and can be collected by, for example, weather radar 122 previously described in connection with FIG. 1. The other PIREP data can include, for example, aircraft location, region, altitude, and/or type, as previously described herein, and can be collected by, for example, instrumentation 124 previously described in connection with FIG. 1.

At block 356, method 350 includes preparing a virtual PIREP that includes the collected weather data and the other collected PIREP data. The virtual PIREP can be prepared, for example, using PIREP data collector 114 and/or PIREP formatter 116 previously described in connection with FIG. 1, and the collected data can be included in the virtual PIREP according to a prescribed encoding procedure, as previously described herein.

At block 358, method 350 includes determining whether pilot review of the virtual PIREP is required. Whether pilot review of the virtual PIREP is required can be a configurable setting set by the pilot of the aircraft. As such, determining whether pilot review of the virtual PIREP is required can include determining whether the pilot review setting has been set by the pilot.

If it is determined that pilot review of the virtual PIREP is not required, the virtual PIREP is automatically sent (e.g., transmitted) to a cloud computing device at block 360. The cloud computing device can be, for example, cloud computing device 234 previously described in connection with FIG. 2. The virtual PIREP can be sent to the cloud computing device, for example, via network 232 previously described in connection with FIG. 2 using wireless transceiver 118 previously described in connection with FIG. 1.

If it is determined that pilot review of the virtual PIREP is required, the virtual PIREP is displayed to the pilot of the aircraft for review and approval at block 362. The virtual PIREP can be displayed to the pilot by, for example, avionics display system 101 previously described in connection with FIG. 1. For instance, the virtual PIREP can be displayed to the pilot in a data box on monitor 106 of avionics display system 101. The virtual PIREP can be displayed in a single data box or in multiple data boxes.

At block 364, method 350 includes determining whether pilot approval of the virtual PIREP has been received. If it is determined that pilot approval of the virtual PIREP has been received, the virtual PIREP is automatically sent to the cloud computing device at block 360, and is also automatically sent to other aircraft subscribed to a PIREP subscription service at block 366. The other subscribed aircraft can be, for example, aircraft 246 previously described in connection with FIG. 2.

As an example, the virtual PIREP displayed to the pilot can include an icon (e.g., button) for the pilot to select that indicates the pilot approves the virtual PIREP. If the pilot approves (e.g., concurs with) the virtual PIREP, the pilot can select (e.g., touch) the icon to indicate his or her approval, and the virtual PIREP can be automatically sent to the cloud computing device and the other subscribed aircraft in response to the pilot’s selection.

If it is determined that pilot approval of the virtual PIREP has not been received, then the virtual PIREP is ignored at block 368 (e.g., the virtual PIREP is not sent to the cloud computing device or the subscribed aircraft). As an example, the virtual PIREP displayed to the pilot can include an additional icon (e.g., additional button) for the pilot to select that indicates the pilot does not approve the virtual PIREP. If the pilot does not approve (e.g., does not concur with) the virtual PIREP, the pilot can select the icon to indicate his or her disapproval, and the virtual PIREP is not sent to the cloud computing device or the subscribed aircraft.

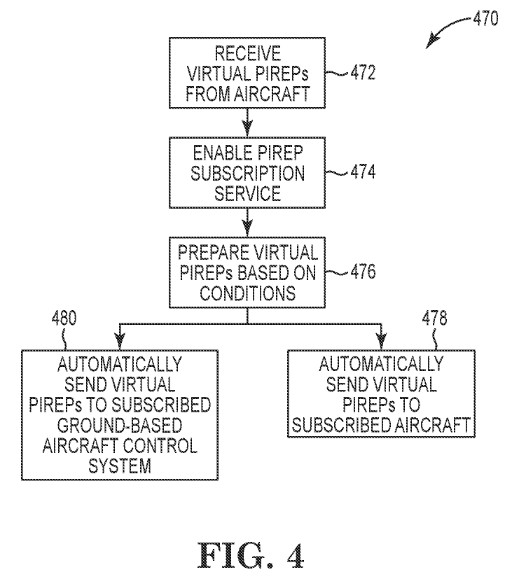

FIG. 4 illustrates an example of a method 470 for automatic collection and dissemination of pilot reports in accordance with one or more embodiments of the present disclosure. Method 470 can be performed by, for example, cloud computing device 234 previously described in connection with FIG. 2.

At block 472, method 470 includes receiving (e.g., collecting) a number of virtual PIREPs from aircraft. The virtual PIREPs can be received, for example, from avionics systems of the aircraft (e.g., aircraft avionics system 100 and/or 200 previously described in connection with FIGS. 1 and 2, respectively) via network 232 previously described in connection with FIG. 2. For instance, the virtual PIREPs can be virtual PIREPs sent at block 360 of FIG. 3.

The virtual PIREPs can include weather data (e.g., lighting data, icing data, turbulence data, hail data, and/or wind data) and other PIREP data (e.g., aircraft location, region, altitude, and/or type), as previously described herein. As an example, the virtual PIREPs can include weather data, the type of the aircraft from which the virtual PIREP was received, and the region in which the aircraft from which the virtual PIREP was received is located.

At block 474, method 470 includes enabling a PIREP subscription service. For instance, enabling the PIREP subscription service can include establishing (e.g., identifying) aircraft and ground-based aircraft control systems that are included in (e.g., subscribed to) the PIREP subscription service.

At block 476, method 470 includes preparing the virtual PIREPs to send to the aircraft included in the PIREP subscription service based on conditions associated with the aircraft, such as, for instance, the type of the aircraft, weather data, and the region in which the aircraft is located. For example, a virtual PIREP may be prepared to be sent to all subscribed aircraft whose type, weather, and/or region match the type, weather, and/or region of the aircraft from which the virtual PIREP was received (e.g., the aircraft type, weather, and/or region data included in the virtual PIREP). In some embodiments, the virtual PIREPs may be prepared using artificial intelligence and/or based on historical data analytics. The virtual PIREPs may also be prepared to be sent to the ground-based aircraft control systems included in the PIREP subscription service.

At block 478, method 470 includes automatically sending (e.g., disseminating) the virtual PIREPs to the subscribed aircraft whose conditions (e.g., type, weather, and/or region) match the data included in the virtual PIREPs. The subscribed aircraft can be, for example, aircraft 246 previously described in connection with FIG. 2. Further, at block 480, method 470 includes automatically sending the virtual PIREPs to the subscribed ground-based aircraft control systems (e.g., ground-based aircraft control system 240 previously described in connection with FIG. 2). The virtual PIREPs can be sent to the subscribed aircraft and the subscribed ground-based aircraft control systems via a network, as previously described herein in connection with FIG. 2.

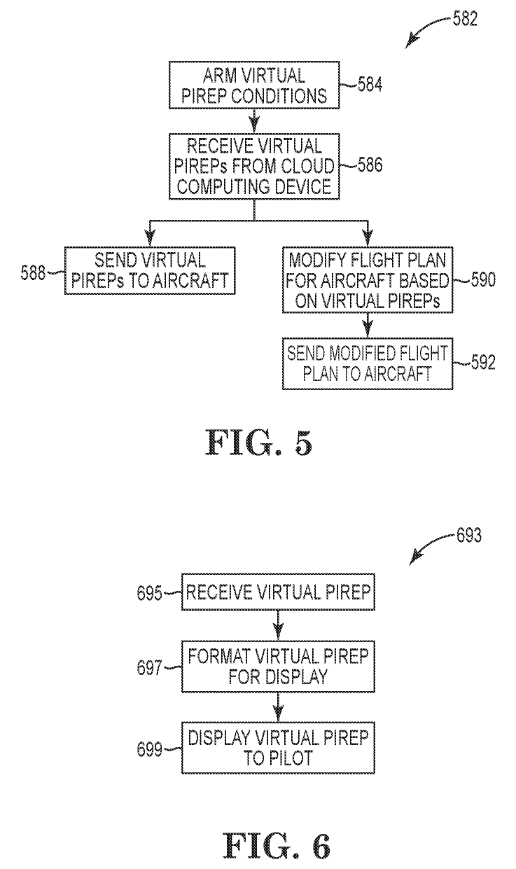

FIG. 5 illustrates an example of a method 582 for automatic collection and dissemination of pilot reports in accordance with one or more embodiments of the present disclosure. Method 582 can be performed by, for example, ground-based aircraft control system 240 previously described in connection with FIG. 2.

At block 584, method 582 includes arming conditions under which virtual PIREPs must be prepared. For example, the conditions under which virtual PIREPs must be prepared can be defined, and the defined conditions can be sent to aircraft to activate the process to determine when to prepare the virtual PIREPs to send to the cloud computing device, as previously described herein.

At block 586, method 582 includes receiving virtual PIREPs from the cloud computing device (e.g., cloud computing device 240 previously described in connection with FIG. 2). The virtual PIREPs can be, for example, the virtual PIREPs sent at block 480 of FIG. 4, and can be received via a network, as previously described in connection with FIG. 2. The virtual PIREPs may be prepared, for instance, by aircraft avionics system 200 in response to the conditions armed at block 584 being met.

At block 588, method 582 includes sending the virtual PIREPs to other aircraft. As an example, block 588 may be performed in embodiments in which the ground-based aircraft control system is an ATC system, and the virtual PIREPs can be sent to targeted aircraft in a particular region, as previously described herein.

At block 590, method 582 includes modifying the flight plans for other aircraft, and at block 592 method 582 includes sending the modified flight plans to those aircraft. As an example, blocks 590 and 592 may be performed in embodiments in which the ground-based aircraft control system is an AOC system. For instance, the flight plans for a fleet of aircraft controlled by the AOC system can be optimized to avoid severe weather and/or take advantage of tail winds, and those optimized flight plans can be sent to the aircraft of the fleet, as previously described herein.

FIG. 6 illustrates an example of a method 693 for automatic collection and dissemination of pilot reports in accordance with one or more embodiments of the present disclosure. Method 693 can be performed by, for example, aircraft 246 previously described in connection with FIG. 2.

At block 695, method 693 includes receiving a virtual PIREP. The virtual PIREP can be received from, for example, aircraft avionics system 100 and/or 200 previously described in connection with FIGS. 1 and 2, respectively, or from cloud computing device 234 previously described in connection with FIG. 2, and can be received via a network, as previously described in connection with FIG. 2. For instance, the virtual PIREP can be a virtual PIREP sent at block 366 of FIG. 3 or a virtual PIREP sent at block 478 of FIG. 4. The virtual PIREP can be received, for example, using an aircraft avionics system analogous to aircraft avionics system 100 previously described in connection with FIG. 1.

At block 697, method 693 includes formatting the virtual PIREP for display. At block 699, method 693 includes displaying the virtual PIREP to the pilot of the aircraft. The virtual PIREP can be formatted and displayed, for example, using an aircraft avionics system analogous to aircraft avionics system 100 previously described in connection with FIG. 1. The pilot of the aircraft can take an action based on the virtual PIREP, such as, for instance, adjusting the flight path of the aircraft, as previously described herein.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
automatically collecting, by an avionics system of an aircraft, data for preparing a pilot report (PIREP);
preparing, by the avionics system of the aircraft, a virtual PIREP that includes the collected data;
sending, by the avionics system of the aircraft, the virtual PIREP to a computing device located remotely from the aircraft;
determining, by the computing device, additional aircraft to send the virtual PIREP to based on the data included in the virtual PIREP and conditions associated with the additional aircraft; and
automatically sending, by the computing device, the virtual PIREP to the additional aircraft.

2. The method of claim 1, wherein the method includes automatically sending, by the avionics system of the aircraft, the virtual PIREP to the additional aircraft.

3. The method of claim 1, wherein the method includes sending, by the computing device, the virtual PIREP to a ground-based aircraft control system.

4. The method of claim 1, wherein the method includes displaying, by the avionics system of the aircraft, the virtual PIREP to a pilot of the aircraft prior to sending the virtual PIREP to the computing device.

5. The method of claim 1, wherein the method includes determining the additional aircraft to send the PIREP to by determining the additional aircraft that have conditions associated therewith that match the data included in the virtual PIREP.

6. The method of claim 1, wherein the method includes automatically displaying, by an avionics system of the additional aircraft, the virtual PIREP to a pilot of the additional aircraft

7. The method of claim 1, wherein the collected data includes weather data.

8. The method of claim 1, wherein the collected data includes:
a location of the aircraft;
an altitude of the aircraft; and
a type of the aircraft.

9. A computing device, comprising:
a processor; and
a memory storing non-transitory machine-readable instructions to cause the processor to:
receive a number of virtual pilot reports (PIREPs);
enable a PIREP subscription service;
prepare the number of virtual PIREPs to send to aircraft included in the PIREP subscription service based on:
type of the aircraft;
weather data; and
region of the aircraft; and
automatically send the number of virtual PIREPs to the aircraft.

10. The computing device of claim 9, wherein the computing device is a cloud-based computing device.

11. The computing device of claim 9, wherein the instructions cause the processor to prepare the number of virtual PIREPs to send to aircraft included in the PIREP subscription service based on historical analytics.

12. The computing device of claim 9, wherein the instructions cause the processor to:
prepare the number of virtual PIREPs to send to ground-based aircraft control systems; and
send the number of virtual PIREPs to the ground-based aircraft control systems.

13. The computing device of claim 9, wherein the aircraft are not equipped with weather radar or access to weather services.

14. The computing device of claim 9, wherein the instructions cause the processor to send the number of virtual PIREPs to the aircraft without using a data connection established with a ground-based aircraft control system.

15. A non-transitory computer readable medium storing instructions executable by a processing resource to cause the processing resource to:
receive a number of virtual pilot reports (PIREPs);
enable a PIREP subscription service;
prepare the number of virtual PIREPs to send to aircraft included in the PIREP subscription service and a ground-based aircraft control system included in the PIREP subscription based on data included in the virtual PIREPs and conditions associated with the aircraft; and
automatically send the number of virtual PIREPs to the aircraft and the ground-based aircraft control system.

16. The computer readable medium of claim 15, wherein the instructions are further executable to send the number of virtual PIREPs from the ground-based aircraft control system to additional aircraft in a particular region.

17. The computer readable medium of claim 15, wherein the instructions are further executable to:
modify, by the ground-based aircraft control system, a flight plan for the aircraft based on the number of virtual PIREPs; and
send, by the ground-based aircraft control system, the modified flight plan to the aircraft.

18. The computer readable medium of claim 15, wherein the instructions are further executable to:
define, by the ground-based aircraft control system, conditions under which the virtual PIREPs must be prepared; and
send, by the ground-based aircraft control system, the defined conditions to aircraft from which the virtual PIREPs are received.

19. The computer readable medium of claim 15, wherein the ground-based aircraft control system is an aeronautical operational control system.

20. The computer readable medium of claim 15, wherein the ground-based aircraft control system is an air traffic control system.
